(19) United States
(12) Patent Application Publication
(10) Pub. No.: US 2024/0410038 A1
(43) Pub. Date: Dec. 12, 2024

(54) ELECTRICAL SOFT IRON STEEL BAR

(71) Applicant: JFE STEEL CORPORATION, Chiyoda-ku, Tokyo (JP)

(72) Inventors: Katsuyuki ICHIMIYA, Chiyoda-ku, Tokyo (JP); Koichi NAKASHIMA, Chiyoda-ku, Tokyo (JP); Yuta IMANAMI, Chiyoda-ku, Tokyo (JP)

(73) Assignee: JFE STEEL CORPORATION, Chiyoda-ku, Tokyo (JP)

(21) Appl. No.: 18/698,482

(22) PCT Filed: Apr. 28, 2022
(86) PCT No.: PCT/JP2022/019445

§ 371 Date: Apr. 4, 2024

(30) Foreign Application Priority Data
Nov. 12, 2021 (WO) PCT/JP2021/041798

(51) Int. Cl. C22C 38/04; C22C 38/00; C22C 38/02; C22C 38/06

(52) U.S. Cl. CPC C22C 38/04; C22C 38/001; C22C 38/002; C22C 38/02; C22C 38/06

(57) ABSTRACT

A steel material having excellent cold workability as well as a high level of magnetic properties and machinability by cutting. As the steel material, an electrical soft iron steel bar includes the following chemical composition, in mass %: C: less than 0.02%, Si: less than 0.023%, Mn: 0.01% or more to 0.50% or less, P: 0.002% or more to 0.020% or less, S: more than 0.02% to 0.050% or less, Al: more than 0.010% to 0.050% or less, N: 0.0010% or more to 0.0100% or less, and B: 0.0003% or more to 0.0065% or less, with the balance being iron and inevitable impurity.

### TECHNICAL FIELD

The present disclosure relates to electrical soft iron steel bars.

### BACKGROUND

In recent years, there has been worldwide demand for resource and energy conservation from the perspective of protecting the global environment. In the field of electrical equipment, improvements in efficiency and miniaturization are being actively promoted for the purpose of energy conservation. Against this background, there is a demand for power conservation, improved response speed to external magnetic fields, and the like, in electrical components used in automobiles and the like.

Pure iron-based electrical soft iron is typically used as a material that responds easily to external magnetic fields. Steel material having a C content of approximately 0.01 mass % or less is used for such electrical soft iron, which is typically produced as electrical components by forging, cutting work, and the like performed on steel bars obtained by wire drawing after hot rolling, and the like.

Here, the soft ferrite single-phase microstructure of electrical soft iron is known to have very poor workability of cutting in component working. Therefore, in addition to magnetic properties, it is becoming increasingly important for electrical soft iron to have excellent workability, in particular both machinability by cutting and cold workability.

For example, Patent Literature (PTL) 1 describes a technology for producing a soft magnetic steel material having excellent magnetic properties and machinability by cutting, by controlling the size and number of MnS when dispersing MnS in the steel.

Further, PTL 2 describes a technology related to a soft magnetic steel material having excellent cold forgeability, machinability by cutting, and magnetic properties, in which the size and density of FeS precipitates are controlled.

### CITATION LIST

### Patent Literature

PTL 1: JP 2007-051343 A
PTL 2: JP 2007-046125 A

### SUMMARY

### Technical Problem

The technologies described in PTL 1 and PTL 2 are technologies for improving machinability by cutting through the independent effect of MnS or FeS. However, an increase in the amount of these precipitates (MnS, FeS) may cause degradation of magnetic properties. Accordingly, there were technical limitations in achieving both magnetic properties and workability at a higher level.

The present disclosure made in view of these circumstances, and it would be helpful to provide a steel material having excellent cold workability as well as a high level of magnetic properties and machinability by cutting.

### Solution to Problem

The inventors have conducted extensive studies into the above-described problem and newly discovered that by utilizing BN formed by including a defined amount of B (boron) and N (nitrogen), machinability by cutting and cold workability may be improved while maintaining good magnetic properties.

The present disclosure is based on these novel discoveries and further investigation conducted by the inventors. The primary features of the present disclosure are as follows.

[1] An electrical soft iron steel bar comprising a chemical composition containing (consisting of), in mass %,
C: less than 0.02%,
Si: less than 0.023%,
Mn: 0.01% or more and 0.50% or less,
P: 0.002% or more and 0.020% or less,
S: more than 0.020% and 0.050% or less,
Al: more than 0.010% and 0.050% or less,
N: 0.0010% or more and 0.0100% or less, and
B: 0.0003% or more and 0.0065% or less,
with the balance being iron and inevitable impurity.

[2] The electrical soft iron steel bar according to [1] above, the chemical composition further containing, in mass %, at least one element selected from the group consisting of:
Cu: 0.20% or less,
Ni: 0.30% or less,
Cr: 0.30% or less,
Mo: 0.10% or less,
V: 0.02% or less,
Nb: less than 0.015%, and
Ti: less than 0.010%.

[3] The electrical soft iron steel bar according to [1] or [2] above, the chemical composition further containing, in mass %, at least one element selected from the group consisting of:
Pb: 0.30% or less,
Bi: 0.30% or less,
Te: 0.30% or less,
Se: 0.30% or less,
Ca: 0.0100% or less,
Mg: less than 0.0050%,
Zr: 0.200% or less, and
REM: 0.0100% or less.

### Advantageous Effect

The present disclosure provides an electrical soft iron steel bar as a steel material having excellent cold workability as well as a high level of magnetic properties and machinability by cutting.

### DETAILED DESCRIPTION

The following is a description of an embodiment of an electrical soft iron steel bar (also referred to as “the steel bar of the present embodiment”).

First, reasons are described for the limitation of each basic component in the chemical composition of the electrical soft iron, the material of the steel bar of the present embodiment. When components (elements) are expressed in “%”, this refers to “mass %” unless otherwise specified.

Further, the content of each component (element) may be measured by spark discharge atomic emission spectrometry, X-ray fluorescence analysis, inductively coupled plasma (ICP) optical emission spectrometry, ICP mass spectrometry, a combustion method, or the like.

C: Less than 0.02%

When C content is 0.02% or more, magnetic properties deteriorate significantly due to magnetic aging. The C content is therefore less than 0.02%. From the same perspective, the C content is preferably 0.015% or less. The C content is more preferably 0.010% or less. Further, the C content is preferably 0.001% or more, as the effect on magnetic properties saturates when the C content is less than 0.001%, while reducing the C content to less than 0.001% is accompanied by an increase in refining costs.

Si: Less than 0.023%

Si is an effective deoxidizing element. Si content of 0.023% or more hardens ferrite and reduces cold workability. The Si content is therefore less than 0.023%. From the same perspective, the Si content is preferably 0.020% or less. The Si content is more preferably 0.017% or less. The Si content may be 0%, but in order to be effective as a deoxidizing element, the Si content is preferably 0.001% or more. The Si content is more preferably 0.002% or more.

### Mn: 0.01% or More and 0.50% or Less

In addition to being effective in improving strength through solid solution strengthening, Mn is an effective element in improving machinability by cutting, through dispersion of MnS combined with S in the steel. To obtain this effect, Mn content is 0.01% or more. However, excessive addition degrades magnetic properties, and therefore the Mn content is 0.50% or less. From the same perspective, the Mn content is preferably 0.05% or more. The Mn content is more preferably 0.15% or more. Further, the Mn content is preferably 0.40% or less. The Mn content is more preferably 0.35% or less.

### P: 0.002% or More and 0.020% or Less

P is an element that exhibits significant solid solution strengthening ability even when added in relatively small amounts. To obtain this effect, P content is 0.002% or more. However, excessive addition reduces cold workability, and therefore the P content is 0.020% or less. From the same perspective, the P content is preferably 0.015% or less.

S: More than 0.020% and 0.050% or Less

S forms MnS in steel and contributes to improved machinability by cutting. When S content is 0.020% or less, the effect of improving machinability by cutting may not be sufficiently and reliably expressed. The S content is therefore more than 0.020%. However, addition exceeding 0.050% decreases cold workability. The S content is therefore 0.050% or less. From the same perspective, the S content is preferably 0.045% or less. The S content is more preferably 0.040% or less.

Al: More than 0.010% and 0.050% or Less

Al is an effective deoxidizing material. Adding Al in excess of 0.010% lowers the amount of oxygen in molten steel, reduces harmful oxides, and improves the yield rate of alloying elements. However, adding Al in excess of 0.050% deteriorates workability and magnetic properties due to an increase in Al oxides and the like. Al content is therefore more than 0.010% and 0.050% or less. From the same perspective, the Al content is preferably 0.045% or less. The Al content is more preferably 0.040% or less.

### N: 0.0010% or More and 0.0100% or Less

N can combine with B in steel material to form BN, which contributes to improved machinability by cutting. To obtain this effect, N content of 0.0010% or more is required. However, addition in excess of 0.0100% deteriorates cold workability and/or magnetic properties, and therefore the N content is 0.0100% or less. From the same perspective, the N content is preferably 0.0015% or more. Further, the N content is preferably 0.0090% or less.

### B: 0.0003% or More and 0.0065% or Less

B can combine with N in steel material to form BN, which contributes to improved machinability by cutting. To obtain this effect, B content of 0.0003% or more is required. However, addition in excess of 0.0065% degrades magnetic properties and/or castability, and therefore the B content is 0.0065% or less. From the same perspective, the B content is preferably 0.0005% or more. The B content is more preferably 0.0010% or more. Further, the B content is preferably 0.0060% or less. The B content is more preferably 0.0055% or less.

The above is a description of the basic components in the chemical composition of electrical soft iron.

The chemical composition of electrical soft iron may further contain any one or more of the elements listed below in addition to the components listed above, as required.
Cu: 0.20% or less
Ni: 0.30% or less
Cr: 0.30% or less
Mo: 0.10% or less
V: 0.02% or less
Nb: less than 0.015%
Ti: less than 0.010%

Cu, Ni, and Cr contribute to strength increase mainly through solid solution strengthening. Therefore, in order to obtain the above effect, when Cu is included, Cu content is preferably 0.01% or more. Similarly, when Ni is included, Ni content is preferably 0.01% or more. Similarly, when Cr is included, Cr content is preferably 0.01% or more.

However, excessive addition of any of Cu, Ni, and Cr degrades magnetic properties. Therefore, as mentioned above, when Cu is included, the Cu content is preferably 0.20% or less. Similarly, when Ni is included, the Ni content is preferably 0.30% or less. Similarly, when Cr is included, the Cr content is preferably 0.30% or less.

Mo, V, Nb, and Ti contribute to strength increase mainly through strengthening by precipitation. Therefore, in order to obtain the above effect, when Mo is included, Mo content is preferably 0.001% or more. Similarly, when Vis included, V content is preferably 0.0001% or more. Similarly, when Nb is included, Nb content is preferably 0.0001% or more. Similarly, when Ti is included, Ti content is preferably 0.0001% or more.

However, excessive addition of any of Mo, V, Nb, and Ti degrades magnetic properties and/or cold workability. Therefore, as mentioned above, when Mo is included, the Mo content is preferably 0.10% or less. Similarly, when Vis included, the V content is preferably 0.02% or less. Similarly, when Nb is included, the Nb content is preferably less than 0.015%. Similarly, when Ti is included, the Ti content is preferably less than 0.010%.

The chemical composition of electrical soft iron may further contain any one or more of the elements listed below in addition to the components listed above, as required.
Pb: 0.30% or less
Bi: 0.30% or less
Te: 0.30% or less
Se: 0.30% or less
Ca: 0.0100% or less
Mg: less than 0.0050%
Zr: 0.200% or less
REM: 0.0100% or less

Pb, Bi, Te, Se, Ca, Mg, Zr, and REM are elements that contribute to machinability by cutting. Therefore, in order to obtain the above effect, when Pb is included, Pb content is preferably 0.001% or more. Similarly, when Bi is included, Bi content is preferably 0.001% or more. Similarly, when Te is included, Te content is preferably 0.001% or more. Similarly, when Se is included, Se content is preferably 0.001% or more. Similarly, when Ca is included, Ca content is preferably 0.0001% or more. Similarly, when Mg is included, Mg content is preferably 0.0001% or more. Similarly, when Zr is included, Zr content is preferably 0.005% or more. Similarly, when REM is included, REM content is preferably 0.0001% or more.

However, excessive addition of any of Pb, Bi, Te, Se, Ca, Mg, Zr, and REM degrades magnetic properties and/or cold workability. Therefore, upper limits of Pb, Bi, Te, Se, Ca, Mg, Zr, and REM content are respectively preferably set as described above.

The chemical composition of electrical soft iron other than the above components (the balance) is iron (Fe) and inevitable impurity.

The following describes main properties of the steel bar of the present embodiment.

The steel bar of the present embodiment preferably has a critical upset ratio of 55% or more. When the critical upset ratio is 55% or more, better cold workability may be exhibited.

The critical upset ratio is defined as the upset ratio of the steel bar when a test piece is compressed until a crack having a width of 0.5 mm or more occurs at a notch bottom. The test piece is taken at a depth position of ½ the diameter from the circumferential surface of the steel bar, and has a diameter of 15 mm, a height of 22.5 mm, and a notch on a side having a depth of 0.8 mm and a notch bottom radius of 0.15 mm.

The steel bar of the present embodiment preferably has a deformation resistance of 550 MPa or less. When the deformation resistance is 550 MPa or less, better cold workability may be exhibited.

Deformation resistance is defined as the value obtained by taking a cylindrical test piece at a depth position of ½ the diameter from the circumferential surface of the steel bar, the test piece having a diameter of 20 mm and a height of 30 mm, measuring a load applied when the test piece is subjected to a 30% reduction in height, and then converting that value into a deformation resistance value in accordance with the cold deformation test method of the Japan Society for Technology of Plasticity (Journal of the Japan Society for Technology of Plasticity, 22 (1981), p. 139).

The steel bar of the present embodiment is preferably a steel bar obtained by rolling, such as bar rolling. In other words, the steel bar of the present embodiment is preferably a rolled steel bar. Rolled steel bars typically have a cross-section aspect ratio (major axis/minor axis) of 1.10 or less after the critical upset ratio test described above. When the cross-section aspect ratio after the test is 1.10 or less, the critical upset ratio may be properly evaluated. However, steel bars obtained from steel plates rolled from the top and bottom in the thickness direction, such as steel sheet rolling, and processed into bars having a circular cross section, have a cross-section shape after the upsetting described above that is not circular but elliptical. That is, the cross-section aspect ratio becomes greater than 1.10. The present disclosure is intended for steel bars for applications where electrical components are made by forging, cutting work, and the like. After machining into component shapes, the cross-section is often circular, and from the perspective of securing dimensional accuracy of components, the closer the cross-section shape is to a perfect circle after the upsetting processing, the more preferable. Further, bearing in mind that the steel bar is subjected to machining by lathe turning after the upsetting processing, the cross-section shape after upsetting is preferably close to a perfect circle from the viewpoint of workability of cutting. The cross-section aspect ratio after upsetting being 1.10 or less can secure ease of machining into components. Further, the cross-section aspect ratio after the critical upset ratio test tends to be larger for thinner steel sheets after finishing, in particular for steel sheets having a thickness of 7 mm or less.

The steel bar of the present embodiment has excellent machinability by cutting, and therefore use in applications where cutting work is performed is preferable. In other words, the steel bar of the present embodiment is preferably a steel bar for cutting.

The following describes a preferred method of producing the steel bar of the present embodiment.

For example, molten steel having the chemical composition described above is melted by a typical melting method using a converter, electric furnace, and the like, and made into steel material by a typical continuous casting or blooming method. The steel material is then heated as required and hot rolled by bar rolling or the like to make an electrical soft iron steel bar. The conditions of heating and rolling described above are not particularly limited, but are preferably determined according to required material properties. For example, the microstructure is preferably controlled to be advantageous for forging and machining for subsequent component forming.

Other production conditions are preferably in accordance with typical methods of producing steel material.

### EXAMPLES

The present disclosure is more specifically described with reference to Examples. The present disclosure is not limited to the following Examples.

After obtaining molten steel having the chemical compositions listed in Tables 1 and 2, hot forging (bar rolling) was performed at about 1200° C., followed by annealing treatment at 950° C. to produce 25 mm diameter bars (rolled steel bars). The obtained steel bars were evaluated for magnetic properties (magnetic flux density and coercive force), cold workability (critical upset ratio and deformation resistance), cross-section aspect ratio, and machinability by cutting (flank wear) according to the following methods.

For comparison, steel AAG and steel AAH, which have the same chemical composition as steel AO of the Examples listed in Table 1, were melted and hot rolled (steel sheet rolling) by rolling from top and bottom in the thickness direction at about 1200° C., followed by annealing treatment at 950° C. to produce steel sheets having 7 mm thickness from steel AAG and 16 mm thickness from steel AAH. When attempting to evaluate the cold workability (critical upset ratio) of the obtained steel sheets according to the following method, the cross-section aspect ratios exceeded 1.10 (steel AAG: 1.13, steel AAH: 1.12) and the steel sheets could not be properly evaluated. For steel AAG, a test piece having a diameter of 6 mm and a height of 9 mm and a notch on a side having a depth of 0.8 mm and a notch bottom radius of 0.15 mm was taken from the ½ depth position of the steel sheet, and a compression test was attempted. Further, for steel AAH, a test piece having a diameter of 15 mm and a height of 22.5 mm and a notch on a side having a depth of 0.8 mm and a notch bottom radius of 0.15 mm was taken and a compression test was attempted. The critical upset ratio was not properly evaluated for the above reasons when the test piece cross-section was elliptical, and therefore these steel sheets were not subjected to other tests.

### (Magnetic Properties)

Magnetic properties were measured in accordance with Japanese Industrial Standard JIS C2504. That is, ring-shaped test pieces were taken from the steel bars (material) described above and magnetically annealed at 750° C. for 2 h. The ring-shaped test pieces were then wound with excitation winding (220 turns of primary winding) and detection winding (100 turns of secondary winding) for testing. Magnetic flux density was determined by measuring the B-H curve using a DC magnetizing measurement device. Specifically, the magnetic flux density at 100 A/m and 300 A/m in the magnetization process with a maximum achievable magnetic field of 10,000 A/m was determined. Results are listed in Table 3. When the magnetic flux density at 100 A/m is 1.20 T or more and at 300 A/m is 1.50 T or more, the magnetic property is considered to be excellent.

Further, coercive force was measured using a ring-shaped test piece with the same winding as described above at a reversal magnetization force of ±400 A/m using a DC magnetic property test apparatus. Results are listed in Table 3. When the coercive force is 60 A/m or less, the magnetic property is considered to be excellent.

### [Cold Workability]

Cold workability was evaluated in terms of critical upset ratio and deformation resistance.

For the critical upset ratio, a test piece having a diameter of 15 mm and a height of 22.5 mm and a notch on a side having a depth of 0.8 mm and a notch bottom radius of 0.15 mm was taken at a depth position of ½ the diameter from the circumferential surface of the steel bar, and compression was performed using the test piece. Sequential compressions were performed until cracks of 0.5 mm or more in width were observed at the notch bottom of the test piece. The upset ratio at this time was defined as the critical upset ratio. Results are listed in Table 3.

Further, the deformation resistance was evaluated as the value obtained by taking a cylindrical test piece at a depth position of ½ the diameter from the circumferential surface of the steel bar, the test piece having a diameter of 20 mm and a height of 30 mm, measuring a load applied when the test piece is subjected to a 30% reduction in height, and then converting that value into a deformation resistance value in accordance with the cold deformation test method of the Japan Society for Technology of Plasticity (Journal of the Japan Society for Technology of Plasticity, 22 (1981), p. 139). Results are listed in Table 3.

When the critical upset ratio is 55% or more and the deformation resistance is 550 MPa or less, the cold workability is considered to be excellent.

### [Cross-Section Aspect Ratio]

The cross-section aspect ratio (major axis/minor axis) of the obtained steel bars was measured after testing the critical upset ratio as described above. Results are listed in Table 3.

### [Machinability by Cutting]

Machinability by cutting was evaluated by measuring tool flank wear under the following two conditions.

(Condition 1) Evaluation by measuring tool flank wear after cutting work on a 25 mm diameter steel bar with a coated carbide base metal tool at a cut depth of 0.2 mm, feed rate of 0.15 mm/rev, peripheral speed of 300 m/min, wet, and a cutting length of 1000 mm, using an NC lathe. Results are listed in Table 3.

(Condition 2) Evaluation by measuring tool flank wear after cutting work on a 25 mm diameter steel bar with a coated carbide base metal tool at a cut depth of 0.4 mm, feed rate of 0.15 mm/rev, peripheral speed of 300 m/min, wet, and a cutting length of 1000 mm, using an NC lathe. Results are listed in Table 3.

When the flank wear under both Condition 1 and Condition 2 is 35 μm or less, machinability by cutting is considered to be excellent.

TABLE 1

| Steel bar | | | | | | | | | | | | | |
|---|---|---|---|---|---|---|---|---|---|---|---|---|---|
| No. | C | Si | Mn | P | S | Al | N | B | Cu | Ni | Cr | Mo | V |
| A | 0.004 | 0.018 | 0.137 | 0.010 | 0.020 | 0.014 | 0.006 | 0.0016 | — | — | — | — | — |
| B | 0.005 | 0.015 | 0.217 | 0.005 | 0.007 | 0.022 | 0.007 | 0.0024 | 0.03 | — | — | — | — |
| C | 0.009 | 0.027 | 0.201 | 0.012 | 0.024 | 0.023 | 0.005 | 0.0007 | — | 0.05 | — | — | — |
| D | 0.002 | 0.010 | 0.205 | 0.008 | 0.022 | 0.013 | 0.005 | 0.0012 | — | — | — | 0.005 | — |
| E | 0.007 | 0.016 | 0.241 | 0.012 | 0.020 | 0.024 | 0.003 | 0.0018 | — | — | — | — | 0.0011 |
| F | 0.007 | 0.018 | 0.226 | 0.008 | 0.020 | 0.022 | 0.004 | 0.0023 | — | — | — | — | — |
| G | 0.003 | 0.019 | 0.241 | 0.009 | 0.009 | 0.014 | 0.005 | 0.0010 | — | — | — | — | — |
| H | 0.005 | 0.026 | 0.124 | 0.007 | 0.011 | 0.024 | 0.006 | 0.0008 | — | — | — | — | — |
| I | 0.008 | 0.014 | 0.160 | 0.011 | 0.018 | 0.031 | 0.002 | 0.0012 | — | — | — | — | — |
| J | 0.007 | 0.010 | 0.215 | 0.003 | 0.022 | 0.032 | 0.006 | 0.0026 | — | 0.02 | — | — | — |
| K | 0.007 | 0.020 | 0.212 | 0.008 | 0.011 | 0.029 | 0.002 | 0.0027 | — | — | 0.02 | — | — |
| L | 0.009 | 0.019 | 0.113 | 0.011 | 0.018 | 0.021 | 0.007 | 0.0021 | 0.02 | — | — | — | — |
| M | 0.026 | 0.029 | 0.169 | 0.003 | 0.014 | 0.034 | 0.005 | 0.0034 | — | — | — | — | — |
| N | 0.004 | 0.310 | 0.118 | 0.005 | 0.018 | 0.036 | 0.006 | 0.0017 | 0.11 | — | — | — | — |
| O | 0.006 | 0.017 | 0.740 | 0.011 | 0.010 | 0.035 | 0.005 | 0.0024 | — | 0.16 | — | — | — |
| P | 0.003 | 0.014 | 0.181 | 0.032 | 0.019 | 0.033 | 0.003 | 0.0016 | — | — | — | 0.020 | — |
| Q | 0.004 | 0.020 | 0.142 | 0.003 | 0.094 | 0.032 | 0.003 | 0.0015 | — | — | — | — | 0.0009 |
| R | 0.006 | 0.014 | 0.198 | 0.009 | 0.012 | 0.067 | 0.002 | 0.0018 | — | — | 0.14 | — | — |
| S | 0.009 | 0.024 | 0.131 | 0.009 | 0.012 | 0.034 | 0.0140 | 0.0022 | — | — | — | — | — |
| T | 0.009 | 0.016 | 0.157 | 0.007 | 0.020 | 0.024 | 0.005 | 0.0116 | — | 0.09 | — | — | — |
| U | 0.002 | 0.013 | 0.106 | 0.007 | 0.021 | 0.021 | 0.002 | 0.0007 | — | — | — | — | — |
| V | 0.002 | 0.020 | 0.159 | 0.009 | 0.017 | 0.016 | 0.002 | 0.0006 | 0.54 | — | — | — | — |
| W | 0.010 | 0.026 | 0.176 | 0.003 | 0.007 | 0.022 | 0.004 | 0.0023 | — | 0.61 | — | — | — |
| X | 0.007 | 0.029 | 0.130 | 0.012 | 0.022 | 0.021 | 0.006 | 0.0019 | — | — | 0.73 | — | — |
| Y | 0.004 | 0.011 | 0.195 | 0.009 | 0.008 | 0.021 | 0.002 | 0.0021 | — | — | — | 0.230 | — |
| Z | 0.005 | 0.026 | 0.179 | 0.004 | 0.021 | 0.019 | 0.002 | 0.0017 | — | 0.07 | — | — | 0.0570 |
| AA | 0.009 | 0.013 | 0.219 | 0.011 | 0.023 | 0.018 | 0.006 | 0.0015 | — | — | — | — | — |
| AB | 0.002 | 0.018 | 0.220 | 0.006 | 0.020 | 0.015 | 0.003 | 0.0009 | 0.09 | — | — | — | — |
| AC | 0.006 | 0.017 | 0.240 | 0.003 | 0.019 | 0.016 | 0.003 | 0.0026 | — | — | — | — | — |

| Steel bar | | | | | | | | | | | |
|---|---|---|---|---|---|---|---|---|---|---|---|
| No. | Nb | Ti | Pb | Bi | Te | Se | Ca | Mg | Zr | REM | Remarks |
| A | — | — | — | — | — | — | — | — | — | — | Comparative |
| | | | | | | | | | | | Example |
| B | — | — | 0.050 | — | — | — | — | — | — | — | Comparative |
| | | | | | | | | | | | Example |
| C | — | — | — | — | — | — | — | — | — | — | Comparative |
| | | | | | | | | | | | Example |
| D | — | — | — | — | — | 0.002 | — | — | — | — | Example |
| E | — | — | — | — | — | — | — | — | — | — | Comparative |
| | | | | | | | | | | | Example |
| F | — | 0.0030 | — | — | — | — | — | — | 0.0009 | — | Comparative |
| | | | | | | | | | | | Example |
| G | 0.0008 | — | — | — | — | — | — | 0.0005 | — | — | Comparative |
| | | | | | | | | | | | Example |
| H | — | — | — | — | — | — | — | — | — | 0.001 | Comparative |
| | | | | | | | | | | | Example |
| I | — | — | — | 0.002 | — | — | — | — | — | — | Comparative |
| | | | | | | | | | | | Example |
| J | — | — | — | — | 0.003 | — | — | — | — | — | Example |
| K | — | — | — | — | — | — | — | — | — | — | Comparative |
| | | | | | | | | | | | Example |
| L | — | — | — | — | — | — | 0.0003 | — | — | — | Comparative |
| | | | | | | | | | | | Example |
| M | — | — | — | — | — | — | — | — | — | — | Comparative |
| | | | | | | | | | | | Example |
| N | — | — | — | — | — | — | — | — | — | — | Comparative |
| | | | | | | | | | | | Example |
| O | — | — | — | — | — | — | — | — | 0.0030 | — | Comparative |
| | | | | | | | | | | | Example |
| P | — | — | — | — | — | — | — | — | — | — | Comparative |
| | | | | | | | | | | | Example |
| Q | — | — | — | — | — | — | — | 0.0012 | — | — | Comparative |
| | | | | | | | | | | | Example |
| R | — | — | — | — | — | — | — | — | — | — | Comparative |
| | | | | | | | | | | | Example |
| S | 0.0011 | — | — | — | — | — | — | — | — | — | Comparative |
| | | | | | | | | | | | Example |
| T | — | — | — | — | — | — | — | — | — | — | Comparative |
| | | | | | | | | | | | Example |
| U | — | — | — | — | — | 0.580 | — | — | — | — | Comparative |
| | | | | | | | | | | | Example |
| V | — | — | — | — | — | — | — | — | — | — | Comparative |
| | | | | | | | | | | | Example |
| W | — | — | — | — | — | — | 0.0004 | — | — | — | Comparative |
| | | | | | | | | | | | Example |
| X | — | 0.0009 | — | — | — | — | — | — | — | — | Comparative |
| | | | | | | | | | | | Example |
| Y | — | — | — | — | — | 0.003 | — | — | — | — | Comparative |
| | | | | | | | | | | | Example |
| Z | — | — | — | — | — | — | — | 0.0007 | — | — | Comparative |
| | | | | | | | | | | | Example |
| AA | 0.0340 | — | 0.050 | — | — | — | — | — | — | — | Comparative |
| | | | | | | | | | | | Example |
| AB | — | 0.0321 | — | 0.020 | — | — | — | — | — | — | Comparative |
| | | | | | | | | | | | Example |
| AC | — | — | 0.440 | — | — | — | — | — | — | — | Comparative |
| | | | | | | | | | | | Example |

Note:
Units are in mass %
Note:
Underlining indicates values outside the scope of the present disclosure.

TABLE 2

| Steel bar | | | | | | | | | | | | | |
|---|---|---|---|---|---|---|---|---|---|---|---|---|---|
| No. | C | Si | Mn | P | S | Al | N | B | Cu | Ni | Cr | Mo | V |
| AD | 0.007 | 0.020 | 0.217 | 0.005 | 0.010 | 0.021 | 0.006 | 0.0019 | — | — | — | 0.012 | — |
| AE | 0.003 | 0.026 | 0.192 | 0.003 | 0.012 | 0.023 | 0.007 | 0.0013 | — | 0.11 | — | — | — |
| AF | 0.009 | 0.024 | 0.199 | 0.009 | 0.009 | 0.016 | 0.002 | 0.0012 | — | — | — | — | 0.0005 |
| AG | 0.009 | 0.027 | 0.169 | 0.008 | 0.008 | 0.012 | 0.003 | 0.0014 | 0.07 | — | — | — | — |
| AH | 0.007 | 0.026 | 0.214 | 0.008 | 0.015 | 0.013 | 0.002 | 0.0022 | — | 0.12 | — | — | — |
| AI | 0.005 | 0.016 | 0.102 | 0.005 | 0.010 | 0.016 | 0.007 | 0.0026 | — | — | — | — | — |
| AJ | 0.002 | 0.022 | 0.234 | 0.006 | 0.004 | 0.014 | 0.005 | 0.0019 | — | — | 0.02 | — | — |
| AK | 0.003 | 0.017 | 0.194 | 0.004 | 0.004 | 0.016 | 0.006 | 0.0001 | 0.04 | — | — | — | — |
| AL | 0.018 | 0.028 | 0.210 | 0.005 | 0.021 | 0.018 | 0.005 | 0.0016 | — | 0.03 | — | — | — |
| AM | 0.003 | 0.021 | 0.420 | 0.004 | 0.026 | 0.016 | 0.004 | 0.0015 | — | — | 0.03 | — | — |
| AN | 0.006 | 0.032 | 0.231 | 0.004 | 0.013 | 0.071 | 0.002 | 0.0072 | 0.06 | — | — | 0.017 | — |
| AO | 0.003 | 0.015 | 0.146 | 0.009 | 0.025 | 0.019 | 0.003 | 0.0020 | — | — | — | — | — |
| AP | 0.004 | 0.019 | 0.223 | 0.006 | 0.031 | 0.023 | 0.006 | 0.0026 | 0.04 | — | — | — | — |
| AQ | 0.010 | 0.022 | 0.208 | 0.011 | 0.025 | 0.026 | 0.007 | 0.0008 | — | 0.07 | — | — | — |
| AR | 0.005 | 0.003 | 0.243 | 0.014 | 0.029 | 0.018 | 0.003 | 0.0019 | — | — | — | — | 0.0015 |
| AS | 0.006 | 0.001 | 0.228 | 0.009 | 0.022 | 0.021 | 0.005 | 0.0027 | — | — | — | — | — |
| AT | 0.003 | 0.016 | 0.252 | 0.011 | 0.040 | 0.016 | 0.004 | 0.0013 | — | — | — | — | — |
| AU | 0.004 | 0.020 | 0.128 | 0.008 | 0.023 | 0.019 | 0.005 | 0.0009 | — | — | — | — | — |
| AV | 0.007 | 0.016 | 0.173 | 0.010 | 0.024 | 0.033 | 0.003 | 0.0013 | — | — | — | — | — |
| AW | 0.006 | 0.020 | 0.224 | 0.007 | 0.029 | 0.026 | 0.003 | 0.0025 | — | — | 0.03 | — | — |
| AX | 0.008 | 0.017 | 0.120 | 0.010 | 0.032 | 0.022 | 0.006 | 0.0019 | 0.03 | — | — | — | — |
| AY | 0.016 | 0.021 | 0.213 | 0.006 | 0.024 | 0.020 | 0.004 | 0.0017 | — | 0.02 | — | — | — |
| AZ | 0.005 | 0.018 | 0.225 | 0.008 | 0.051 | 0.025 | 0.004 | 0.0023 | — | — | — | — | — |
| AAA | 0.003 | 0.012 | 0.213 | 0.009 | 0.021 | 0.019 | 0.006 | 0.0013 | — | — | — | — | — |
| AAB | 0.001 | 0.012 | 0.221 | 0.007 | 0.050 | 0.017 | 0.006 | 0.0014 | — | — | — | — | — |
| AAC | 0.008 | 0.013 | 0.209 | 0.004 | 0.024 | 0.011 | 0.004 | 0.0024 | — | — | — | — | — |
| AAD | 0.007 | 0.014 | 0.184 | 0.011 | 0.022 | 0.050 | 0.003 | 0.0016 | — | — | — | — | — |
| AAE | 0.009 | 0.019 | 0.212 | 0.010 | 0.023 | 0.029 | 0.006 | 0.0003 | — | — | — | — | — |
| AAF | 0.007 | 0.004 | 0.229 | 0.008 | 0.028 | 0.026 | 0.006 | 0.0065 | — | — | — | — | — |

| Steel bar | | | | | | | | | | | |
|---|---|---|---|---|---|---|---|---|---|---|---|
| No. | Nb | Ti | Pb | Bi | Te | Se | Ca | Mg | Zr | REM | Remarks |
| AD | — | — | — | 0.520 | — | — | — | — | — | — | Comparative |
| | | | | | | | | | | | Example |
| AE | — | — | — | — | 0.490 | — | — | — | — | — | Comparative |
| | | | | | | | | | | | Example |
| AF | — | — | — | — | — | — | 0.0160 | — | — | 0.002 | Comparative |
| | | | | | | | | | | | Example |
| AG | — | — | — | — | 0.005 | — | — | 0.0120 | — | — | Comparative |
| | | | | | | | | | | | Example |
| AH | — | — | — | — | — | — | — | — | 0.2300 | — | Comparative |
| | | | | | | | | | | | Example |
| AI | — | — | — | — | — | — | — | — | — | 0.012 | Comparative |
| | | | | | | | | | | | Example |
| AJ | — | — | — | — | — | — | 0.0003 | — | — | — | Comparative |
| | | | | | | | | | | | Example |
| AK | 0.0013 | — | — | — | 0.004 | — | — | — | — | — | Comparative |
| | | | | | | | | | | | Example |
| AL | — | 0.0012 | — | — | — | — | — | — | — | — | Comparative |
| | | | | | | | | | | | Example |
| AM | — | — | — | — | — | — | — | — | — | — | Example |
| AN | — | — | — | — | 0.003 | — | — | — | — | — | Comparative |
| | | | | | | | | | | | Example |
| AO | — | — | — | — | — | — | — | — | — | — | Example |
| AP | — | — | 0.052 | — | — | — | — | — | — | — | Example |
| AQ | — | — | — | — | — | — | — | — | — | — | Example |
| AR | — | — | — | — | — | — | — | — | — | — | Example |
| AS | — | 0.0028 | — | — | — | — | — | — | 0.0010 | — | Example |
| AT | 0.001 | — | — | — | — | — | — | 0.0009 | — | — | Example |
| AU | — | — | — | — | — | — | — | — | — | 0.001 | Example |
| AV | — | — | — | 0.003 | — | — | — | — | — | — | Example |
| AW | — | — | — | — | — | — | — | — | — | — | Example |
| AX | — | — | — | — | — | — | 0.0004 | — | — | — | Example |
| AY | — | 0.0015 | — | — | — | — | — | — | — | — | Example |
| AZ | — | — | — | — | — | — | — | — | — | — | Comparative |
| | | | | | | | | | | | Example |
| AAA | — | — | — | — | — | — | — | — | — | — | Example |
| AAB | — | — | — | — | — | — | — | — | — | — | Example |
| AAC | — | — | — | — | — | — | — | — | — | — | Example |
| AAD | — | — | — | — | — | — | — | — | — | — | Example |
| AAE | — | — | — | — | — | — | — | — | — | — | Example |
| AAF | — | — | — | — | — | — | — | — | — | — | Example |

Note:
Units are in mass %
Note:
Underlining indicates values outside the scope of the present disclosure.

TABLE 3

| | Magnetic property | | | | | | | | |
|---|---|---|---|---|---|---|---|---|---|
| | Magnetic flux | Magnetic flux | | Cold workability | | Cross- | Machinability by cutting | | |
| | density | density | Coercive | Critical | Deformation | section | Amount of wear | Amount of wear | |
| Steel bar | at 100 A/m | at 300 A/m | force | upset ratio | resistance | aspect | [Condition 1] | [Condition 2] | |
| No. | (T) | (T) | (A/m) | (%) | (MPa) | ratio | (μm) | (μm) | Remarks |
| A | 1.235 | 1.534 | 50.2 | 63.5 | 519 | 1.03 | 20.2 | 36.7 | Comparative |
| | | | | | | | | | Example |
| B | 1.280 | 1.586 | 48.5 | 59.3 | 528 | 1.02 | 29.6 | 43.2 | Comparative |
| | | | | | | | | | Example |
| C | 1.266 | 1.564 | 45.0 | 63.7 | 570 | 1.05 | 22.4 | 34.5 | Comparative |
| | | | | | | | | | Example |
| D | 1.221 | 1.534 | 47.0 | 63.9 | 517 | 1.03 | 25.8 | 30.4 | Example |
| E | 1.227 | 1.541 | 52.3 | 56.1 | 531 | 1.01 | 27.5 | 37.3 | Comparative |
| | | | | | | | | | Example |
| F | 1.202 | 1.511 | 47.5 | 60.8 | 536 | 1.02 | 29.6 | 38.0 | Comparative |
| | | | | | | | | | Example |
| G | 1.275 | 1.579 | 45.9 | 59.6 | 541 | 1.01 | 25.8 | 44.7 | Comparative |
| | | | | | | | | | Example |
| H | 1.213 | 1.503 | 45.0 | 58.4 | 559 | 1.04 | 26.8 | 41.3 | Comparative |
| | | | | | | | | | Example |
| I | 1.250 | 1.553 | 47.9 | 62.6 | 525 | 1.03 | 21.9 | 37.7 | Comparative |
| | | | | | | | | | Example |
| J | 1.241 | 1.540 | 51.7 | 60.9 | 516 | 1.02 | 21.0 | 29.7 | Example |
| K | 1.226 | 1.542 | 48.2 | 56.1 | 533 | 1.02 | 22.5 | 42.5 | Comparative |
| | | | | | | | | | Example |
| L | 1.214 | 1.512 | 53.9 | 55.3 | 524 | 1.04 | 29.3 | 41.5 | Comparative |
| | | | | | | | | | Example |
| M | 1.120 | 1.404 | 84.1 | 66.1 | 582 | 1.03 | 29.7 | 42.9 | Comparative |
| | | | | | | | | | Example |
| N | 1.282 | 1.609 | 54.3 | 49.5 | 564 | 1.02 | 34.2 | 40.7 | Comparative |
| | | | | | | | | | Example |
| O | 1.284 | 1.588 | 74.2 | 56.7 | 595 | 1.02 | 20.3 | 35.6 | Comparative |
| | | | | | | | | | Example |
| P | 1.268 | 1.570 | 45.5 | 42.3 | 536 | 1.02 | 24.9 | 36.2 | Comparative |
| | | | | | | | | | Example |
| Q | 1.249 | 1.571 | 56.5 | 41.7 | 542 | 1.04 | 25.3 | 34.7 | Comparative |
| | | | | | | | | | Example |
| R | 1.116 | 1.386 | 54.7 | 63.3 | 530 | 1.03 | 22.2 | 40.9 | Comparative |
| | | | | | | | | | Example |
| S | 1.242 | 1.562 | 81.2 | 47.1 | 562 | 1.04 | 26.6 | 41.6 | Comparative |
| | | | | | | | | | Example |
| T | 1.130 | 1.432 | 51.2 | 57.3 | 559 | 1.02 | 28.7 | 36.0 | Comparative |
| | | | | | | | | | Example |
| U | 1.282 | 1.612 | 74.3 | 51.0 | 528 | 1.04 | 21.4 | 33.8 | Comparative |
| | | | | | | | | | Example |
| V | 1.109 | 1.391 | 79.2 | 65.3 | 547 | 1.04 | 26.9 | 37.5 | Comparative |
| | | | | | | | | | Example |
| W | 1.097 | 1.384 | 74.3 | 58.8 | 556 | 1.08 | 26.4 | 42.3 | Comparative |
| | | | | | | | | | Example |
| X | 1.142 | 1.435 | 75.6 | 64.8 | 561 | 1.01 | 27.5 | 34.7 | Comparative |
| | | | | | | | | | Example |
| Y | 1.139 | 1.432 | 79.1 | 46.2 | 549 | 1.04 | 29.9 | 44.1 | Comparative |
| | | | | | | | | | Example |
| Z | 1.123 | 1.413 | 82.1 | 47.9 | 568 | 1.02 | 23.7 | 34.2 | Comparative |
| | | | | | | | | | Example |
| AA | 1.188 | 1.473 | 89.7 | 49.1 | 542 | 1.03 | 20.3 | 31.6 | Comparative |
| | | | | | | | | | Example |
| AB | 1.174 | 1.470 | 80.6 | 48.1 | 547 | 1.03 | 26.2 | 36.7 | Comparative |
| | | | | | | | | | Example |
| AC | 1.106 | 1.405 | 75.1 | 55.8 | 535 | 1.09 | 23.8 | 34.2 | Comparative |
| | | | | | | | | | Example |
| AD | 1.112 | 1.405 | 74.6 | 56.2 | 540 | 1.02 | 27.9 | 34.6 | Comparative |
| | | | | | | | | | Example |
| AE | 1.162 | 1.465 | 76.2 | 43.2 | 552 | 1.02 | 22.8 | 33.9 | Comparative |
| | | | | | | | | | Example |
| AF | 1.173 | 1.451 | 71.2 | 47.9 | 567 | 1.07 | 22.6 | 39.5 | Comparative |
| | | | | | | | | | Example |
| AG | 1.164 | 1.449 | 72.6 | 46.3 | 565 | 1.04 | 22.0 | 38.8 | Comparative |
| | | | | | | | | | Example |
| AH | 1.159 | 1.452 | 74.2 | 45.6 | 576 | 1.01 | 24.2 | 36.1 | Comparative |
| | | | | | | | | | Example |
| AI | 1.136 | 1.410 | 74.9 | 45.5 | 525 | 1.01 | 22.8 | 39.7 | Comparative |
| | | | | | | | | | Example |
| AJ | 1.212 | 1.521 | 55.4 | 57.3 | 543 | 1.02 | 39.7 | 47.8 | Comparative |
| | | | | | | | | | Example |
| AK | 1.226 | 1.534 | 54.6 | 59.7 | 521 | 1.02 | 40.3 | 48.2 | Comparative |
| | | | | | | | | | Example |
| AL | 1.206 | 1.526 | 52.9 | 57.1 | 575 | 1.03 | 28.7 | 33.9 | Comparative |
| | | | | | | | | | Example |
| AM | 1.209 | 1.537 | 55.9 | 59.3 | 543 | 1.03 | 27.4 | 31.4 | Example |
| AN | 1.175 | 1.507 | 60.9 | 49.6 | 582 | 1.03 | 23.1 | 37.6 | Comparative |
| | | | | | | | | | Example |
| AO | 1.231 | 1.537 | 49.8 | 62.7 | 515 | 1.02 | 21.7 | 29.8 | Example |
| AP | 1.278 | 1.584 | 48.7 | 58.4 | 538 | 1.03 | 21.4 | 28.5 | Example |
| AQ | 1.264 | 1.566 | 45.4 | 61.9 | 542 | 1.09 | 22.0 | 29.3 | Example |
| AR | 1.228 | 1.539 | 52.5 | 57.3 | 531 | 1.03 | 20.9 | 28.1 | Example |
| AS | 1.206 | 1.518 | 47.7 | 60.2 | 527 | 1.04 | 24.9 | 30.8 | Example |
| AT | 1.272 | 1.567 | 46.4 | 57.9 | 540 | 1.03 | 20.1 | 27.4 | Example |
| AU | 1.210 | 1.502 | 45.3 | 57.1 | 518 | 1.01 | 21.3 | 30.2 | Example |
| AV | 1.246 | 1.554 | 48.1 | 62.9 | 525 | 1.01 | 20.9 | 29.7 | Example |
| AW | 1.227 | 1.537 | 48.6 | 56.4 | 537 | 1.04 | 20.6 | 29.4 | Example |
| AX | 1.216 | 1.510 | 53.3 | 55.9 | 514 | 1.03 | 21.1 | 27.9 | Example |
| AY | 1.209 | 1.522 | 52.4 | 57.3 | 539 | 1.08 | 21.8 | 29.5 | Example |
| AZ | 1.226 | 1.520 | 49.0 | 57.0 | 534 | 1.03 | 32.3 | 41.5 | Comparative |
| | | | | | | | | | Example |
| AAA | 1.234 | 1.541 | 47.2 | 62.6 | 516 | 1.01 | 26.5 | 31.2 | Example |
| AAB | 1.225 | 1.548 | 46.5 | 63.1 | 521 | 1.02 | 31.7 | 33.9 | Example |
| AAC | 1.239 | 1.541 | 52.0 | 61.2 | 519 | 1.03 | 21.7 | 29.4 | Example |
| AAD | 1.211 | 1.514 | 54.3 | 56.9 | 531 | 1.02 | 23.5 | 31.4 | Example |
| AAE | 1.273 | 1.576 | 44.1 | 62.4 | 538 | 1.06 | 27.8 | 33.1 | Example |
| AAF | 1.202 | 1.506 | 57.1 | 58.3 | 527 | 1.03 | 29.3 | 32.4 | Example |

From Tables 1 to 3, it can be seen that the steel bars according to the present disclosure have excellent cold workability as well as a high level of magnetic properties and machinability by cutting.

1. An electrical soft iron steel bar comprising a chemical composition containing, in mass %,
C: less than 0.02%,
Si: less than 0.023%,
Mn: 0.01% or more and 0.50% or less,
P: 0.002% or more and 0.020% or less,
S: more than 0.020% and 0.050% or less,
Al: more than 0.010% and 0.050% or less,
N: 0.0010% or more and 0.0100% or less, and
B: 0.0003% or more and 0.0065% or less
with the balance being iron and inevitable impurity.

2. The electrical soft iron steel bar according to claim 1, the chemical composition further containing, in mass %, at least one element selected from the group consisting of:
Cu: 0.20% or less,
Ni: 0.30% or less,
Cr: 0.30% or less,
Mo: 0.10% or less,
V: 0.02% or less,
Nb: less than 0.015%, and
Ti: less than 0.010%.

3. The electrical soft iron steel bar according to claim 1, the chemical composition further containing, in mass %, at least one element selected from the group consisting of:
Pb: 0.30% or less,
Bi: 0.30% or less,
Te: 0.30% or less,
Se: 0.30% or less
Ca: 0.0100% or less,
Mg: less than 0.0050%,
Zr: 0.200% or less, and
REM: 0.0100% or less.

4. The electrical soft iron steel bar according to claim 2, the chemical composition further containing, in mass %, at least one element selected from the group consisting of:
Pb: 0.30% or less,
Bi: 0.30% or less,
Te: 0.30% or less,
Se: 0.30% or less
Ca: 0.0100% or less,
Mg: less than 0.0050%,
Zr: 0.200% or less, and
REM: 0.0100% or less.
